(19) United States
(12) Patent Application Publication
(10) Pub. No.: US 2005/0079764 A1
(43) Pub. Date: Apr. 14, 2005

(54) Memory card connector for mounting on a printed circuit board

(76) Inventor: Yi-Tse Ho, Gian (TW)

Correspondence Address: MOLEX INCORPORATED, 2222 WELLINGTON COURT, LISLE, IL, 60532, US

(21) Appl. No.: 10/952,611

(22) Filed: Sep. 29, 2004

(30) Foreign Application Priority Data
Oct. 14, 2003 (TW) 92218267

(51) Int. Cl. H01R 24/00

(52) U.S. Cl. 439/630

(57) ABSTRACT

A memory card connector is provided for mounting on a printed circuit board having first and second arrays of circuit pads. The connector includes an insulating housing having a rear terminal-mounting section and at least one longitudinal side wall section extending forwardly from one end of the rear section and combining therewith to define a card-receiving space. An array of first terminals are mounted on the rear section and have contact portions projecting into the space for engaging appropriate contacts on a first memory card and tail portions for electrical connection to the first array of contact pads on the printed circuit board. An auxiliary connector is positioned on the housing and is independent thereof. The auxiliary connector includes an array of second terminals having contact portions projecting into the space for engaging appropriate contacts on a second memory card and tail portions for electrical connection to the second array of contact pads on the printed circuit board.

### FIELD OF THE INVENTION

This invention generally relates to the art of electrical connectors and, particularly, to a memory card connector for mounting on a printed circuit board.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card connector often is mounted on a printed circuit board. The memory card, itself, writes or reads via the connector and can transmit between electrical appliances, such as a word processor, personal computer, personal data assistant or the like. The connector terminals typically have tail portions for connection to appropriate circuit traces on the printed circuit board. The tail portions may be connected to the circuit traces by surface mount technology, wherein the tail portions are soldered to the circuit traces. The tails portions may be inserted into through holes in the circuit board for connection, as by soldering, to circuit traces on the board and/or in the holes. In either process, the solder connections involve high temperatures in a reflow process. In other instances, the tail portions simply may be electrically connected to the circuit traces by pressure engagement. This often is accomplished by using screws or other fasteners which run through the connector housing to tightly clamp the housing to the printed circuit board. In all of these processes or systems, problems are encountered when the connections between the tail portions and the circuit traces become loosened or otherwise damaged or the tail portions even becoming separated from the circuit traces. This results in incomplete connections and defective circuitry. The defective connections can be caused by the circuit board bending or warping, for instance.

The above problems are magnified when the memory card connector is designed for receiving more than one memory card. In other words, two different types of memory cards may be insertable individually or conjointly into a single memory card connector. Providing adequate terminations between two different arrays of terminals on the memory card connector with two different arrays of circuit pads on a printed circuit board is considerably compounded. The present invention is directed to solving these problems.

### SUMMARY OF THE INVENTION

An object, therefore, of the invention is to provide a new and improved memory card connector of the character described.

In the exemplary embodiment of the invention, a memory card connector is provided for mounting on a printed circuit board having first and second arrays of circuit pads. The connector includes an insulating housing having a rear terminal-mounting section and at least one longitudinal side wall section extending forwardly from one end of the rear section and combining therewith to define a card-receiving space. An array of first terminals are mounted on the rear section and have contact portions projecting into the space for engaging appropriate contacts on a first memory card and tail portions for electrical connection to the first array of contact pads on the printed circuit board. An auxiliary connector is positioned on the housing and is independent thereof. The auxiliary connector includes an array of second terminals having contact portions projecting into the space for engaging appropriate contacts on a second memory card and tail portions for electrical connection to the second array of contact pads on the printed circuit board.

As disclosed herein, the auxiliary connector includes a dielectric housing mounting the array of second terminals. The insulating housing of the memory card connector includes a receptacle on the underside thereof and which is sized for receiving the dielectric housing of the auxiliary connector facing the printed circuit board. At least one mounting post is provided on the dielectric housing for insertion into a mounting hole in the printed circuit board.

According to one embodiment of the invention, an adapter is mounted on the printed board and includes a dielectric housing mounting adapter terminals electrically connected to the first array of contact pads on the printed circuit board. The tail portions of the first terminals are engageable with the adapter terminals. The insulating housing of the memory card connector includes a pair of rear side wall sections projecting rearwardly from opposite ends of the rear terminal-mounting section. The adapter is positionable between the rear side wall sections.

According to another embodiment of the invention, the printed circuit board has a header connector mounted thereon. An auxiliary printed circuit board is mounted on the insulating housing and is terminated to the tail portions of the first terminals. The auxiliary printed circuit board has a mating portion for insertion into the header connector.

According to a further embodiment of the invention, the printed circuit board again has a header connector mounted thereon. An auxiliary printed circuit board has an auxiliary connector thereon and which is terminated to the tail portions of the first terminals. The auxiliary connector is mateable with the header connector.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded, bottom perspective view of a memory card connector embodying the concepts of a first embodiment of the invention, in conjunction with a printed circuit board on which the connector is mounted;

FIG. 2 is a bottom perspective view of the connector of FIG. 1 in assembled condition;

FIG. 3 is a bottom perspective view of a memory card and printed circuit board according to a second embodiment of the invention;

FIG. 4 is a top perspective view of the connector of FIG. 3, with the rear metal terminal cover removed;

FIG. 5 is an enlarged rear elevational view of a memory card connector and printed circuit board according to a third embodiment of the invention;

FIG. 6 is a fragmented, bottom perspective view of a memory card connector in conjunction with a rear end of a printed circuit board according to a fourth embodiment of the invention; and

FIG. 7 is a top perspective view of one of the memory card connectors mounted in a chassis.

### DETAILED DESCRIPTION OF THE PREFERRED EMBODIMENTS

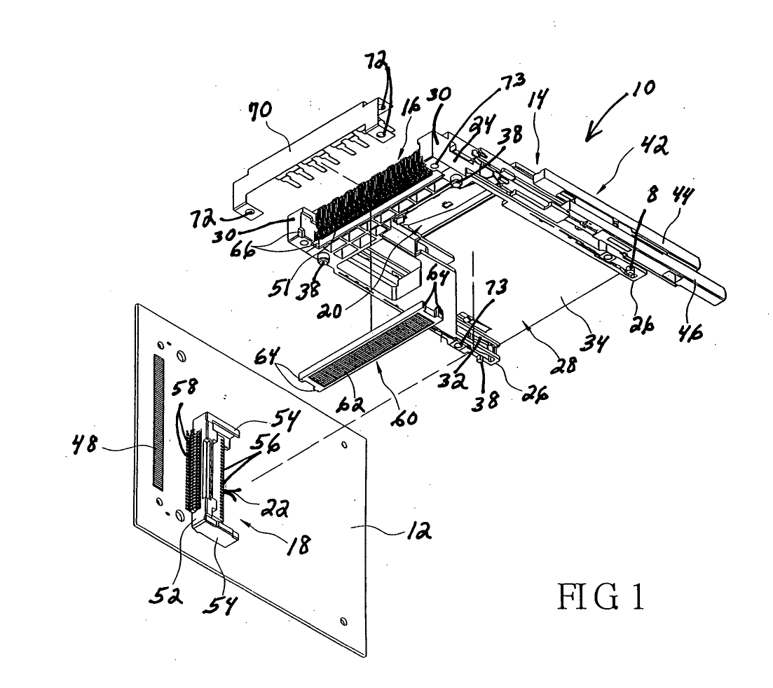

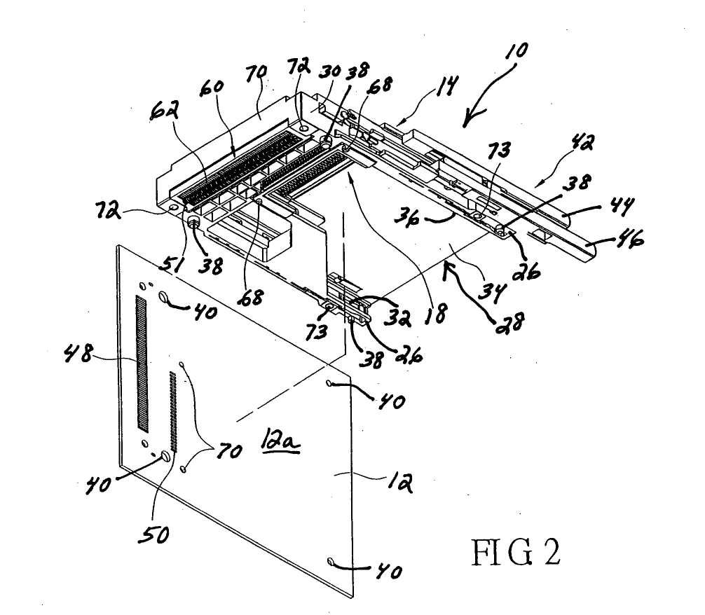

Referring to the drawings in greater detail, and first to FIGS. 1 and 2, the invention is embodied in a memory card connector, generally designated 10, for mounting on a printed circuit board 12 which has a top surface 12a. The connector includes an insulating housing, generally designated 14, which mounts a first array of terminals, generally designated 16. An auxiliary connector, generally designated 18, is mounted in a receptacle, generally designated 20, in the underside of insulating housing 14. The auxiliary connector mounts an array of second terminals, generally designated 22.

More particularly, housing 14 of memory card connector 10 includes a rear terminal-mounting section 24 and a pair of side wall sections 26 which extend forwardly from opposite ends of the rear section to form a generally U-shaped configuration which defines a card-receiving space, generally designated 28, for receiving one or more memory cards. A pair of rear side wall sections 30 project rearwardly from opposite ends of rear terminal-mounting section 24. Each side wall section 26 includes a pair of upper and lower longitudinal grooves 32 for receiving two memory cards. The lower groove is quite visible in FIGS. 1 and 2, but the upper groove is not visible because of the presence of a metal baffle plate 34. Each side wall section includes a baffle groove 36 in the inside surface thereof between the upper and lower longitudinal grooves 32 which receive the two memory cards. Baffle plate 34 is inserted into baffle grooves 36 and provides electromagnetic interference (EMI) protection between the memory cards. A plurality of mounting posts 38 project downwardly from insulating housing 14 for insertion into a plurality of mounting holes 40 in printed circuit board 12. An eject mechanism, generally designated 42, is mounted on one of the side wall sections 26 of insulating housing 14. The eject mechanism includes a pair of independently operable ejecting arms 44 and 46 for independently ejecting one or both of the two memory cards which are insertable into the connector.

Printed circuit board 12 has a first array of contact pads 48 and a second array of contact pads 50. It can be seen in FIG. 2 that the arrays of contact pads are elongated and generally parallel, and the first array of contact pads 48 is longer than the second array of contact pads 50.

As seen best in FIG. 1, first terminals 16 are mounted on the rear terminal-mounting section 24 of insulating housing 14. Each first terminal 16 includes a contact portion which projects into the card-receiving space 28 for engaging appropriate contacts on a first memory card inserted into the top groove 32 between side wall sections 26 of the housing. Again, the contact portions of first terminals 16 are not visible because of the presence of metal baffle plate 34. The first terminals have tail portions 51 projecting downwardly between the rear side wall sections 30 of insulating housing 14 for connection, as by soldering, to the first array of contact pads 48 on printed circuit board 12.

Second terminals 22 are mounted on a dielectric housing 52 of auxiliary connector 18. The housing has wing portions 54 at opposite ends thereof. The second terminals have contact portions 56 which project into the card-receiving space 28 for engaging appropriate contacts on a second memory card inserted into the bottom groove 32 between side wall sections 26 of insulating housing 14. The second terminals have tail portions 58 for connection, as by soldering, to contact pads 50 on circuit board 12.

In order to guide and align tail portions 51 of first terminals 16 into alignment with contact pads 48 on the printed circuit board, an elongated tail alignment plate 60 is provided with through channels 62 through which tail portions 51 extend. The tail alignment plate is mounted between the rear side wall sections 30 of insulating housing 14 by press-fitting a pair of bosses 64 at opposite ends of the plate into a pair of recess 66 in the inside faces of rear side wall sections. The bosses and notches can be polarized or asymmetrical to ensure that the plate is properly positioned in the underside of the housing.

In the embodiment of FIGS. 1 and 2, auxiliary connector 18 is assembled within receptacle 20 in the underside of insulating housing 14. Housing 52 of the auxiliary connector includes a pair of mounting bosses 68 (FIG. 2) which are insertable into a pair of mounting holes 70 in printed circuit board 12 when the connector is mounted to the board.

Finally, the first embodiment includes a metal terminal cover 70 mounted over the rear of insulating housing 14 spanning the end faces of the rear side wall sections 30 of the housing. The metal terminal cover includes a plurality of holes 72 which are aligned with mounting holes 73 through the housing and which receive appropriate fasteners for fastening the connector to printed circuit board 12.

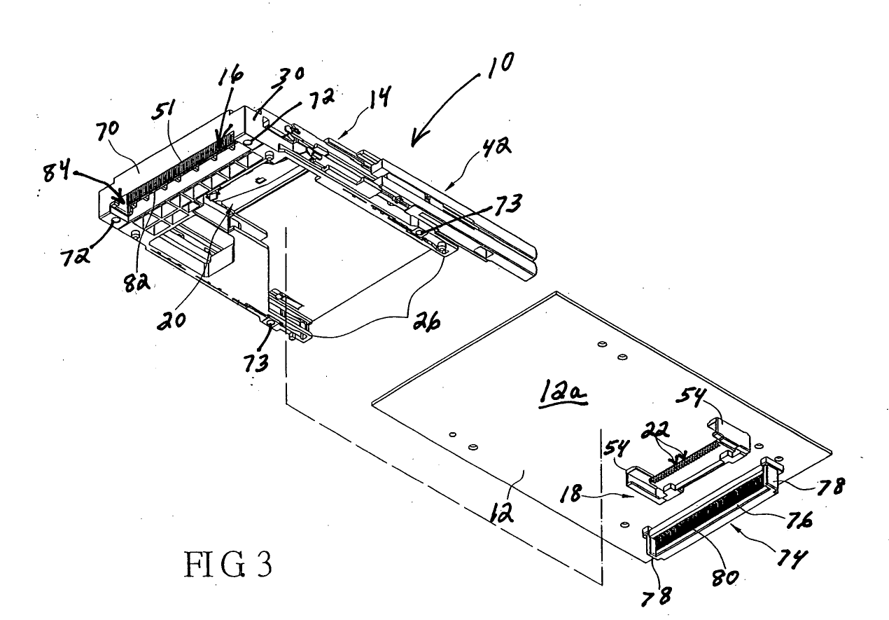

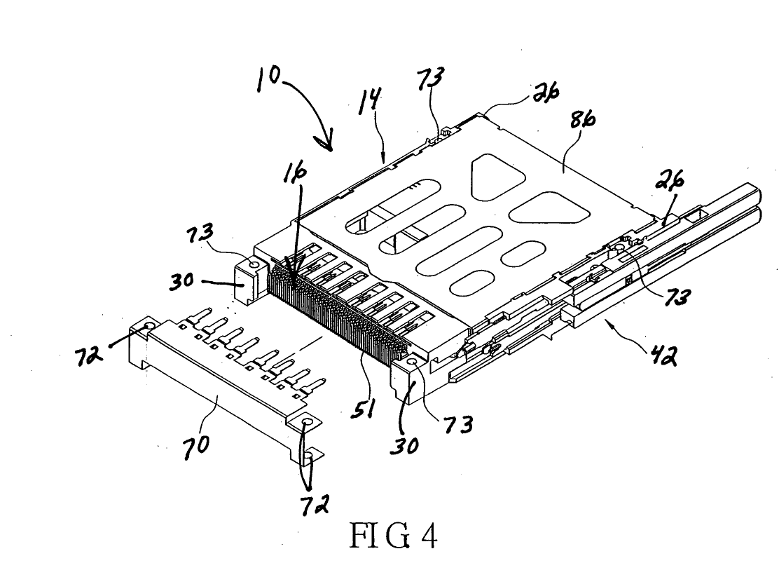

FIGS. 3 and 4 show a second embodiment of the invention. At this point, it should be understood that like reference numerals have been applied to all of the drawings, including the second, third and fourth embodiments of the invention, corresponding to like components described above in relation to the first embodiment of FIGS. 1 and 2. In addition, descriptions of those like components will not be repeated.

The second embodiment of FIGS. 3 and 4 add an adapter, generally designated 74, which is mounted to top surface 12a of printed circuit board 12. The adapter includes an elongated dielectric housing 76 having wing portions 78 at opposite ends thereof. A plurality of adapter terminals are mounted on housing 76 and are terminated, as by soldering, to the first array of contact pads 48 (FIG. 2) on circuit board 12. In this second embodiment, tail portions 51 of first terminals 16 comprise straight portions of the terminals received in generally parallel channels in a rear face of a transverse wall 82 of insulating housing 14. The transverse wall extends between rear side wall sections 30 of insulating housing 14. When memory card connector 10 is mounted on printed circuit board 12, housing 76 of adapter connector 74 moves into an area, generally designated 84 (FIG. 3), between rear side wall sections 30 of insulating housing 14 and inside metal terminal cover 70. When fully inserted, adapter terminals 80 of adapter 74 engage tail portions 51 of first terminals 16.

FIG. 4 also shows that one or all embodiments of the invention include a metal top cover 86 which is not visible in the previously described embodiments of FIGS. 1-3. The metal cover spans side wall sections 26 of insulating housing 14 and provides electromagnetic interference for a substantial portion of the connector.

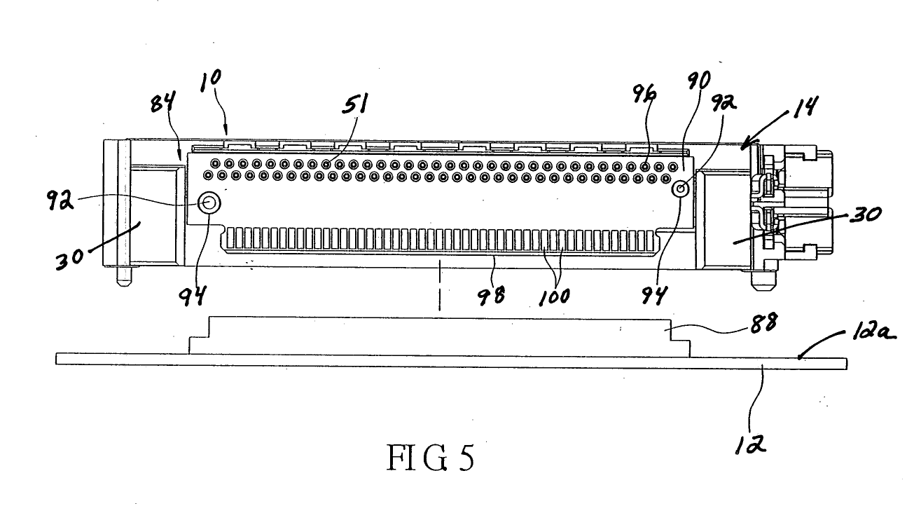

FIG. 5 shows a third embodiment of the invention, wherein a header connector, generally designated 88, is mounted on top surface 12a of main printed circuit board 12. A narrow, elongated auxiliary printed circuit board 90 is mounted at the rear of insulating housing 14, between rear side wall sections 30, by means of a pair of mounting posts 92 projecting through a pair of mounting holes 94 in the auxiliary printed circuit board. Tail portions 51 of first terminals 16 in this third embodiment comprise terminal pins which are inserted through a linear array of holes 96 in the auxiliary printed circuit board. The terminal pins are electrically connected to circuit traces on the auxiliary board and/or in the holes. The auxiliary printed circuit board 90 includes a mating portion in the form of a bottom tongue 98 for insertion into header connector 88 on mating printed circuit board 12. Mating portion 98 includes a linear array of contact pads 100 for electrical mating with appropriate terminals within header connector 88. Contact pads 100 are appropriately coupled by circuitry on the auxiliary printed circuit board to the circuit traces on the board which are electrically engaged with terminal pins 51 of the first terminals.

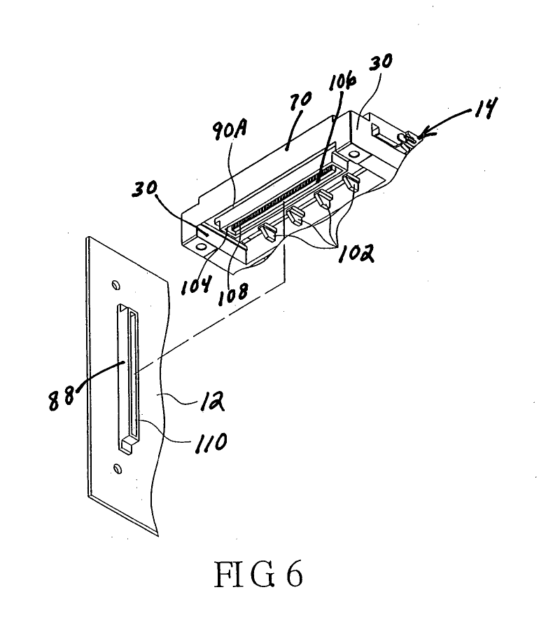

FIG. 6 shows a fourth embodiment of the invention wherein main printed circuit board 12 again has the elongated header connector 88 mounted thereon. In this fourth embodiment, another auxiliary printed circuit board 90A is mounted between side wall sections 30 inside metal terminal cover 70. Auxiliary printed circuit board 90A is in a generally horizontal orientation versus the vertical orientation of auxiliary printed circuit board 90 in the third embodiment of FIG. 5. A plurality of supports 102 support auxiliary printed circuit board 90A in position. An auxiliary connector 104 is mounted to the bottom of auxiliary printed circuit board 90A. The auxiliary connector has a mating plug portion 106 which mounts a plurality of auxiliary terminals 108 on one or both sides thereof. The auxiliary terminals are appropriately terminated to the tail portions of the first terminals mounted on insulating housing 14 of connector 10. When the connector is mounted onto main printed circuit board 12, mating plug portion 106 of auxiliary connector 104 is inserted into an elongated slot 110 of header connector 88 for electrical connection of the auxiliary terminals 108 with appropriate terminals within the header connector which are terminated to the first array of contact pads 42 (FIG. 2) on the main printed circuit board.

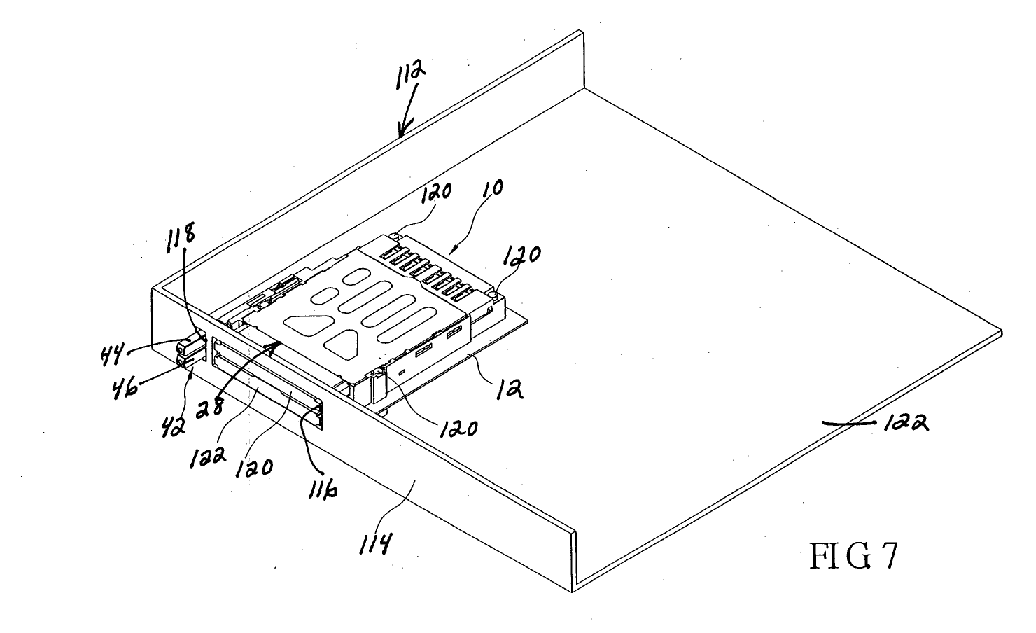

FIG. 7 shows memory card connector 10 mounted on a chassis, generally designated 112, of an electrical appliance. The chassis has an outer or front wall 114 provided with an elongated opening 116 and a smaller opening 118. First and second memory cards 120 and 122 are shown as having been inserted through opening 116 into the card-receiving space 28 of the connector. Ejecting arms 44 and 46 of eject mechanism 42 are shown projecting through opening 118 and exposed for manual manipulation by an operator. Finally, FIG. 7 shows a plurality of fasteners 120 for fastening the connector to circuit board 12 and/or a bottom wall 122 of the chassis.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector for mounting on a printed circuit board having first and second arrays of circuit pads, comprising:
an insulating housing having a rear terminal-mounting section and at least one longitudinal side wall section extending forwardly from one end of the rear section and combining therewith to define a card-receiving space;
an array of first terminals mounted on the rear terminal-mounting section of the housing and having contact portions projecting into said space for engaging appropriate contacts on a first memory card and tail portions for electrical connection to the first array of contact pads on the printed circuit board; and
an auxiliary connector positioned on the housing and independent thereof, and including second terminals having contact portions projecting into said space for engaging appropriate contacts on a second memory card and tail portions for electrical connection to the second array of contact pads on the printed circuit board.

2. The memory card connector of claim 1 wherein said insulating housing includes a receptacle for receiving the auxiliary connector.

3. The memory card connector of claim 2 wherein said receptacle is in the rear terminal-mounting section of the housing.

4. The memory card connector of claim 3 wherein said receptacle is in a bottom location of the rear section facing the printed circuit board.

5. The memory card connector of claim 1 wherein said auxiliary connector includes a dielectric housing mounting said array of second terminals.

6. The memory card connector of claim 5 wherein said insulating housing includes a receptacle in the underside thereof and sized for receiving the dielectric housing of the auxiliary connector.

7. The memory card connector of claim 5 wherein the dielectric housing of said auxiliary connector includes at least one mounting post for insertion into a mounting hole in the printed circuit board.

8. The memory card connector of claim 1, including an adapter mounted on the printed board and including adapter terminals electrically connected to the first array of circuit pads on the printed circuit board, the tail portions of the first terminals being engageable with the adapter terminals.

9. The memory card connector of claim 8 wherein said adapter includes a dielectric housing mounting the adapter terminals.

10. The memory card connector of claim 8 wherein said insulating housing includes a pair of rear side wall sections projecting rearwardly from opposite ends of the rear terminal-mounting section, the adapter being positionable between the rear side wall sections.

11. The memory card connector of claim 1, including a metal terminal cover mounted over the rear of the insulating housing.

12. The memory card connector of claim 1, including a metal baffle plate mounted on the insulating housing in position between the first and second memory cards to provide electromagnetic interference protection between the memory cards.

13. The memory card connector of claim 1 wherein the printed circuit board has a header connector mounted thereon, and including an auxiliary printed circuit board mounted on the insulating housing terminated to the tail portions of the first terminals, the auxiliary printed circuit board including a mating portion for insertion into the header connector.

14. The memory card connector of claim 1 wherein the printed circuit board has a header connector mounted thereon, and including an auxiliary printed circuit board mounted on the insulating housing terminated to the tail portions of the first terminals, the auxiliary printed circuit board having an auxiliary connector mounted thereon for mating with the header connector.
